(19) United States
(12) Patent Application Publication
(10) Pub. No.: US 2016/0244155 A1
(43) Pub. Date: Aug. 25, 2016

(54) HELICOPTER SKID LANDING GEAR

(71) Applicant: Bell Helicopter Textron Inc., Fort Worth, TX (US)

(72) Inventor: William A. Amante, Grapevine, TX (US)

(21) Appl. No.: 14/626,365

(22) Filed: Feb. 19, 2015

(51) Int. Cl. B64C 25/52; B64C 25/32

(52) U.S. Cl. CPC B64C 25/52; B64C 25/32; B64C 2025/325

(57) ABSTRACT

A landing gear for an aircraft can include a skid tube having an inboard flat side wall and an outboard flat side wall, the skid tube having a skid tube centerline plane that is parallel to at least one of the outboard flat side wall and the inboard flat side wall, the skid tube being canted inboard at an angle The landing gear can include a forward cross tube having a straight horizontal portion, a first bend transitioning the straight horizontal portion into a straight angled portion, and a second bend transitioning the straight angled portion into a straight end portion.

### BACKGROUND

1. Technical Field

The embodiments of the present disclosure relate to skid landing gear for a rotorcraft, such as a helicopter.

2. Description of Related Art

Conventional skid landing gear can have significant deficiencies. For example, conventional skid landing gear assemblies can be a significant source of aerodynamic drag. Further, conventional landing gear can be expensive to manufacture do in part to complicated geometries. There is a need for an improved skid landing gear.

### DESCRIPTION OF THE DRAWINGS

The novel features believed characteristic of the methods and apparatuses of the present disclosure are set forth in the appended claims. However, each method and apparatus, as well as a preferred mode of use, and further objectives and advantages thereof, will best be understood by reference to the following detailed description when read in conjunction with the accompanying drawings, wherein:

FIG. 1 is a side view of a rotorcraft according to one example embodiment;

FIG. 2 is a perspective view of a skid landing gear, according to one example embodiment;

FIG. 3 is a view looking aft of a skid landing gear and rotorcraft, according to one example embodiment;

FIG. 4 is a perspective view of a step member of a skid landing gear, according to an example embodiment;

FIG. 5 is a top view of a portion of a step member of a skid landing gear, according to an example embodiment;

FIG. 6 is a side view of a portion of a step member of a skid landing gear, according to an example embodiment;

FIG. 7 is a perspective view of a step member of a skid landing gear, according to an example embodiment;

FIG. 8 is a side view of a skid landing gear, according to one example embodiment;

FIG. 9 is a perspective view of a skid landing gear, according to one example embodiment;

FIG. 10 is a perspective view of a skid landing gear, according to one example embodiment;

FIG. 11 is a cross-sectional view of a skid landing gear, taken from section lines 11-11 in FIG. 2, according to one example embodiment; and

FIG. 12 is a cross-sectional view of a skid landing gear, taken from section lines 12-12 in FIG. 1, according to one example embodiment.

### DETAILED DESCRIPTION

Illustrative embodiments of the methods and apparatuses are described below. It will of course be appreciated that in the development of an actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present disclosure, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

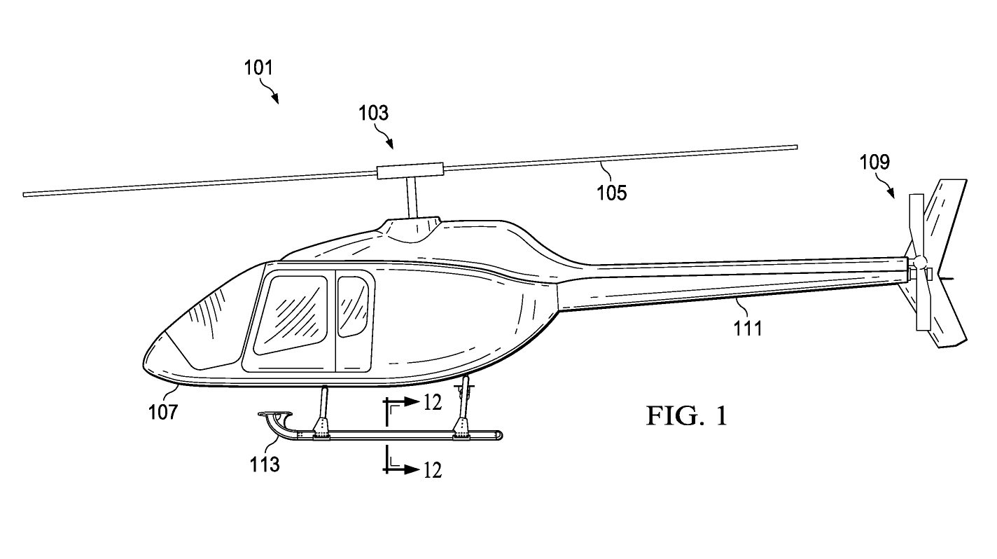

Referring now to FIG. 1 in the drawings, a helicopter 101 is illustrated. Helicopter 101 has a rotor system 103 with a plurality of rotor blades 105. The pitch of each rotor blade 105 can be manipulated in order to selectively control direction, thrust, and lift of helicopter 101. Helicopter 101 can further include a fuselage 107, anti-torque system 109, and a tailboom 111. Helicopter 101 can further include a landing gear 113. Landing gear 113 has significant advantages over conventional landing gear configurations, as discussed further herein.

A helicopter landing gear can appear deceptively simple, but can be complex in analysis, performance, and certification. The landing gear can be one of the last lines of defense for saving lives during a hard landing or crash. Furthermore, it is desirable that the landing gear has a high fatigue life and be very damage resistant. Further, it is desirable that the landing gear promote efficiency of the helicopter by being lightweight and aerodynamic.

The embodiments of the landing gear of the present application have significant benefits and advantages over conventional helicopter landing gear configurations. For example, the landing gear of the present disclosure is: 1) inexpensive to manufacture; 2) lightweight; 3) strong; 4) does not require chemical milling, thus is more environmentally friendly; 5) aerodynamic; and 6) minimized part count. These and other advantages of the landing gear 113 are achieved at least in part by a complimentary combination of the flat side-walled skid tubes that can each be canted inboard at a cant angle, and forward and aft cross tubes each with two bends so as to form three straight sections, each outboard most straight section being oriented at the same cant angle as the corresponding skid tube. The outboard most straight sections of the cross tubes terminate adjacent to the skid tubes and since the outboard most straight sections are canted at the same angle as the skid tubes, the bent sheet metal saddle can be used to join the cross tubes to the skid tubes. The aerodynamic advantages of the landing gear are realized from the step member, the outboard most straight section of the forward cross tube, and the outboard most straight section of the aft cross tube all being in aerodynamic alignment with respect to the fore/aft direction.

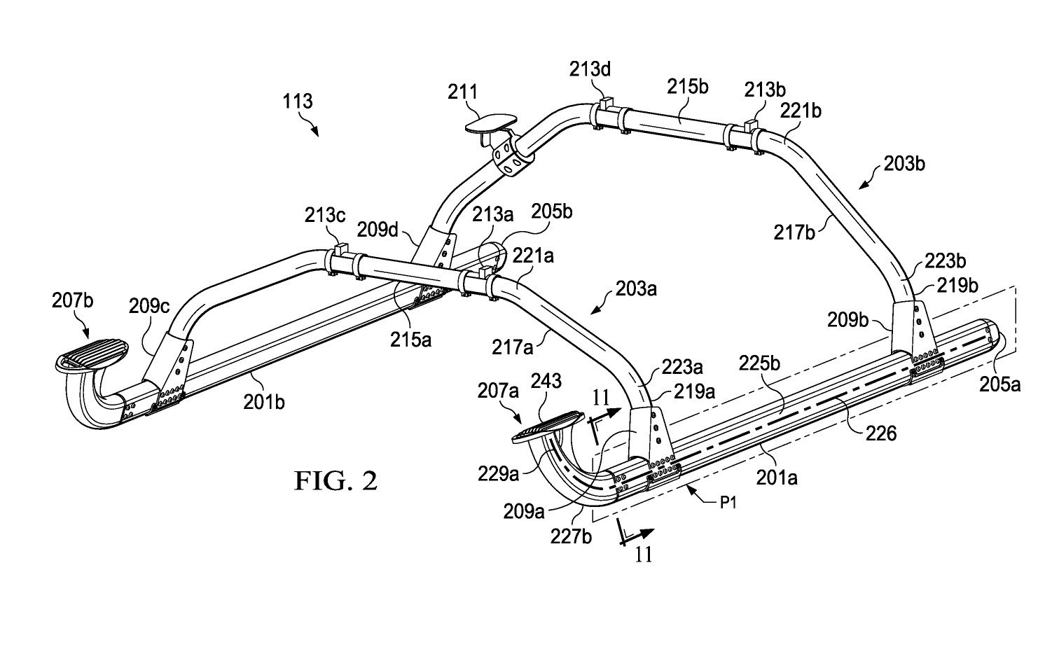

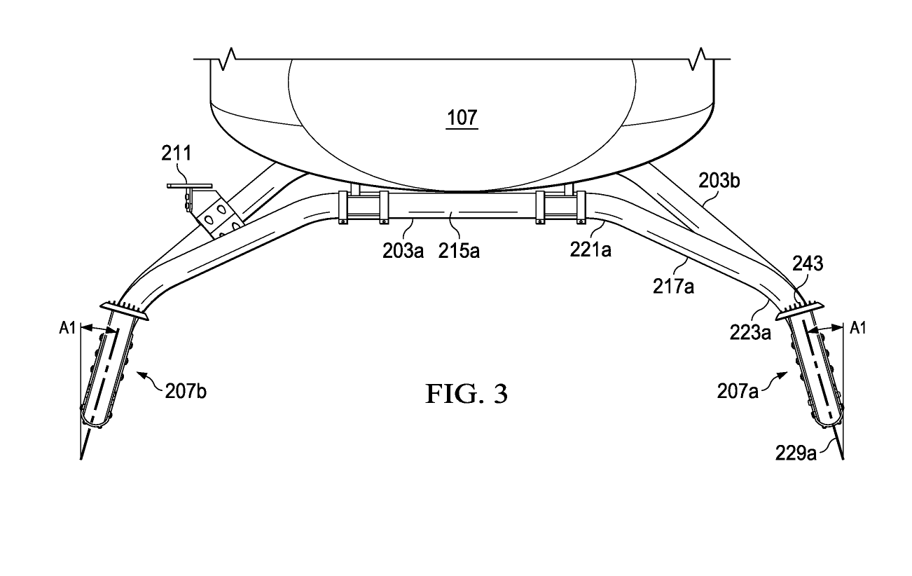

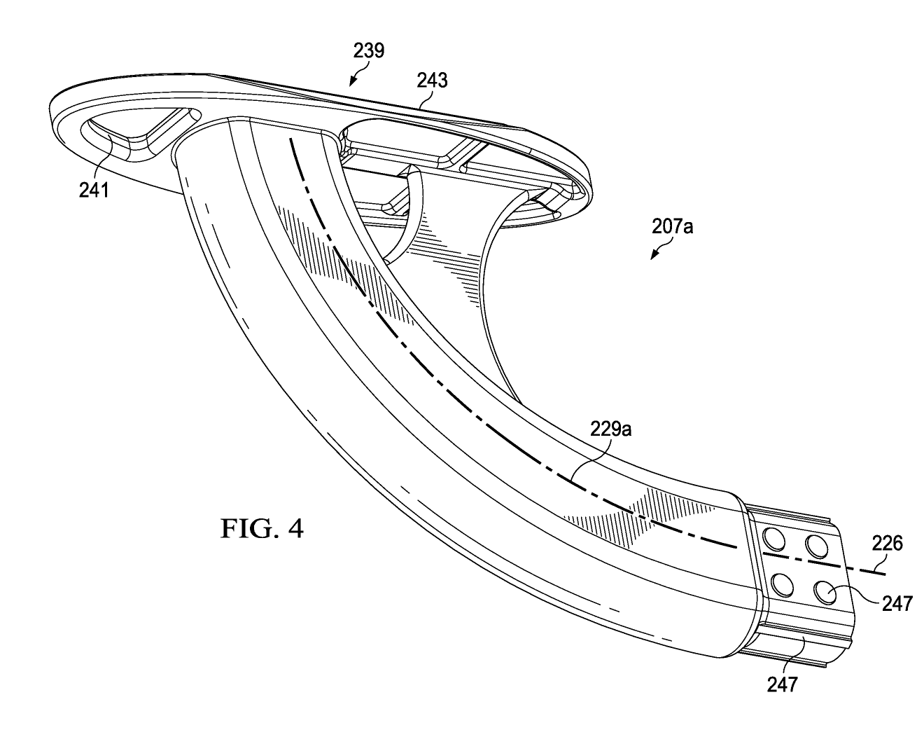

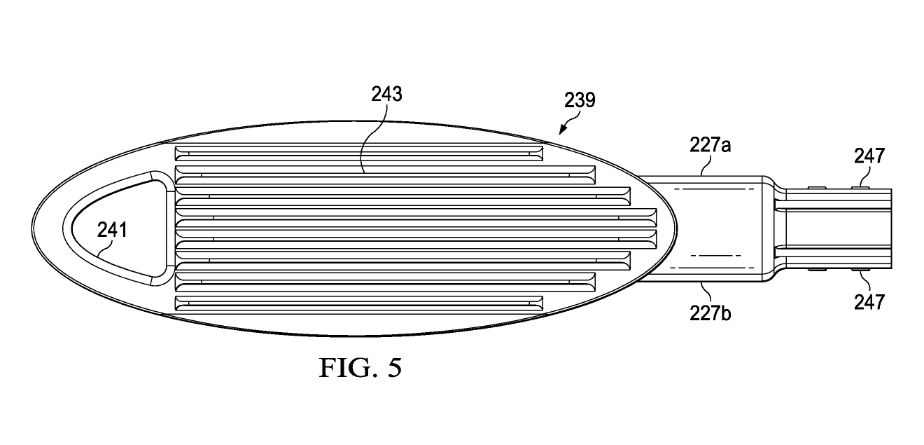

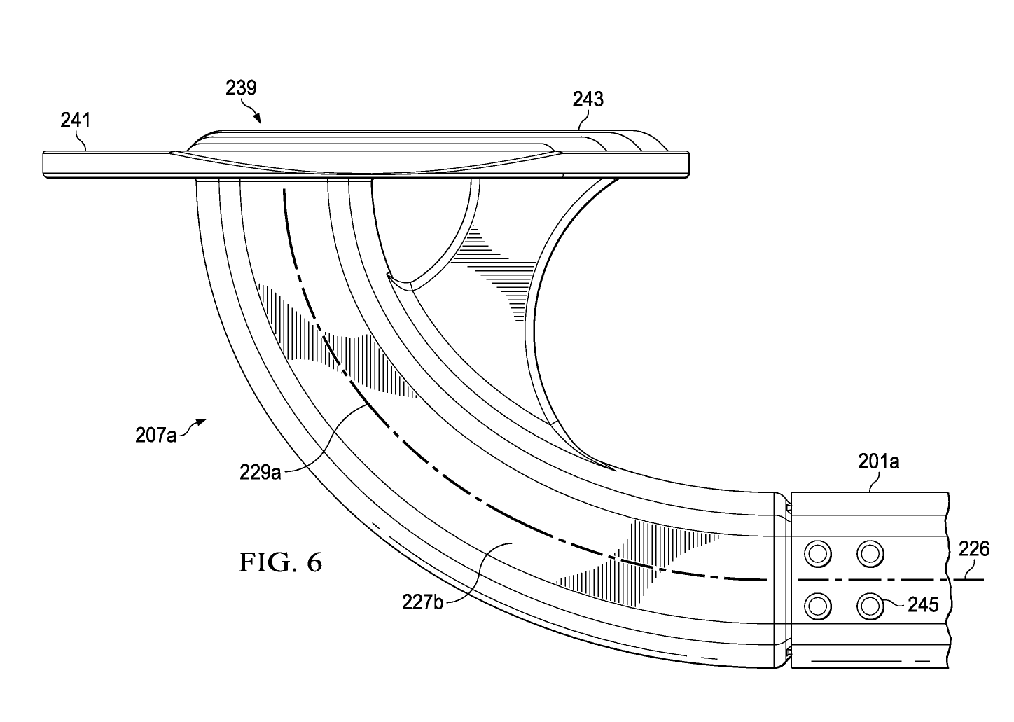

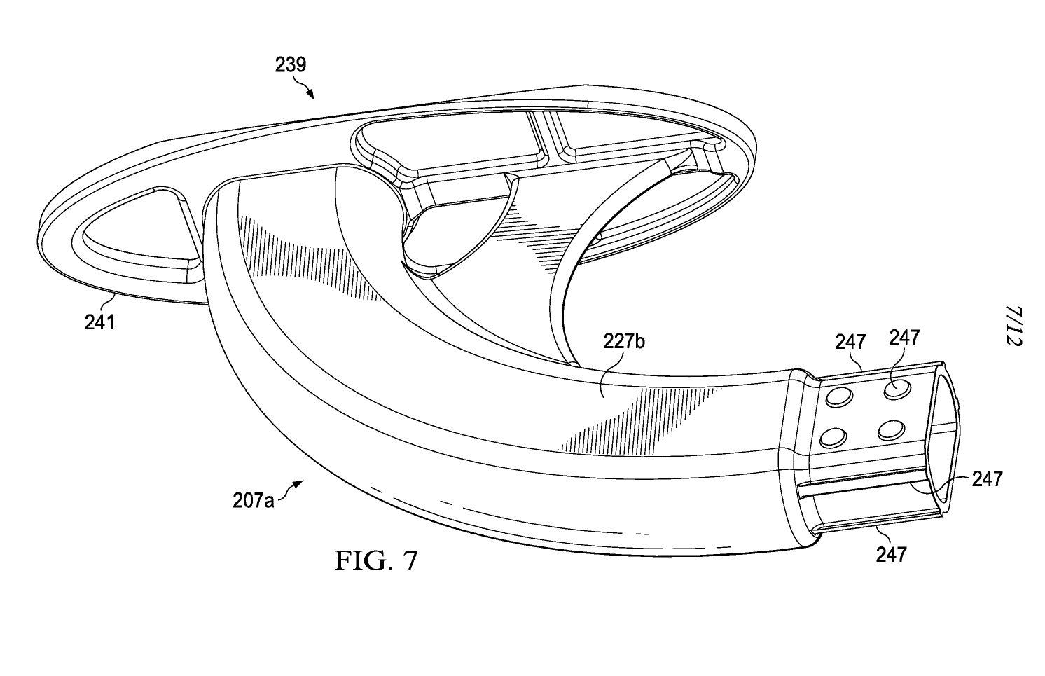

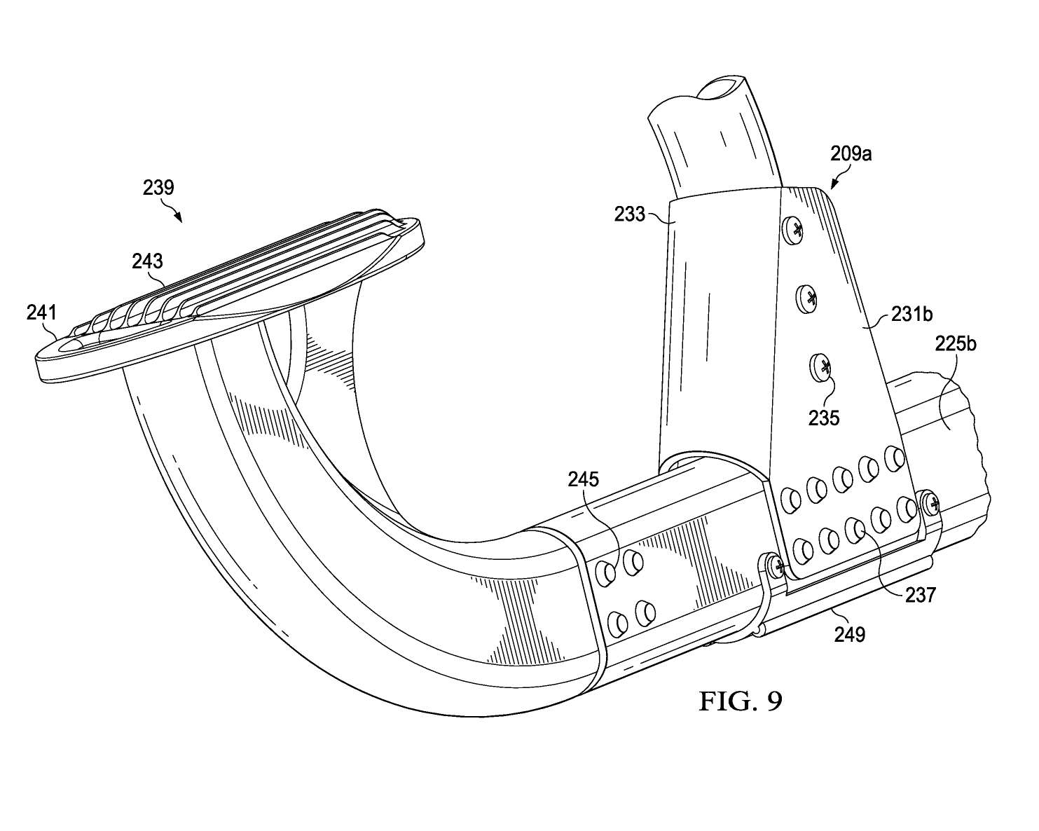

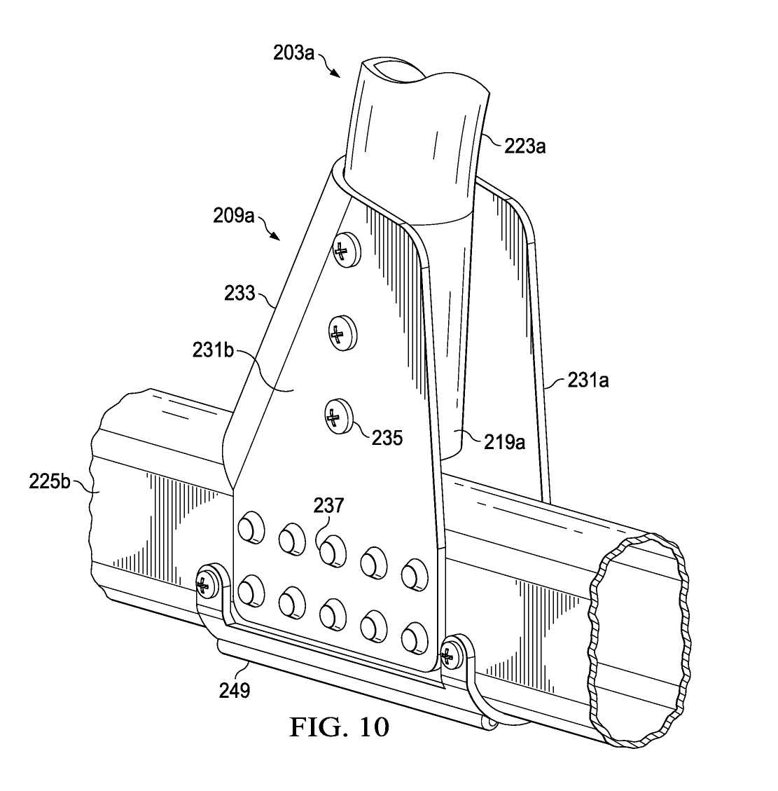

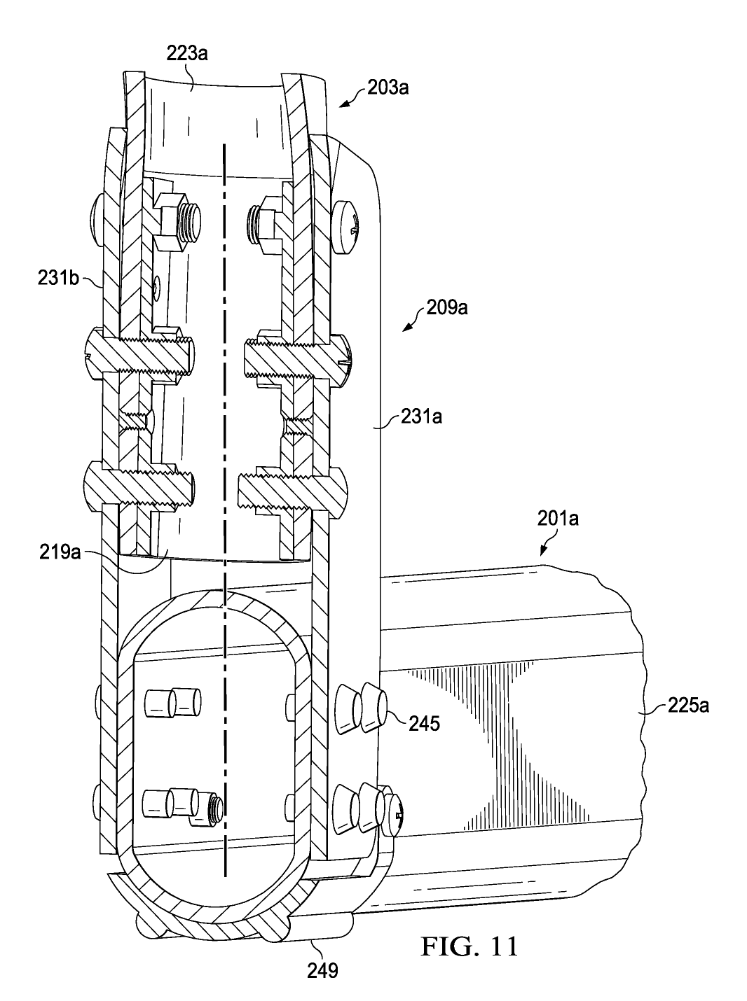

Referring to FIGS. 2-11, landing gear 113 is illustrated in further detail. Landing gear 113 is symmetric between the left and right sides, except that the right side further includes a maintenance step 211, thus for the sake of clarity some features may only be described herein with regard to one of the left or right sides. Landing gear 113 is a “skid” style landing gear having skid tubes 201a and 201b, a forward cross tube 203a, an aft cross tube 203b, step members 207a and 207b, and saddles 209a-209d. Wear plates 249 can be utilized as a replaceable wear surfaces under skid tubes 201a and 201b. Cross tubes 203a and 203b can be coupled to fuselage 107 with attachment members 213a-213d.

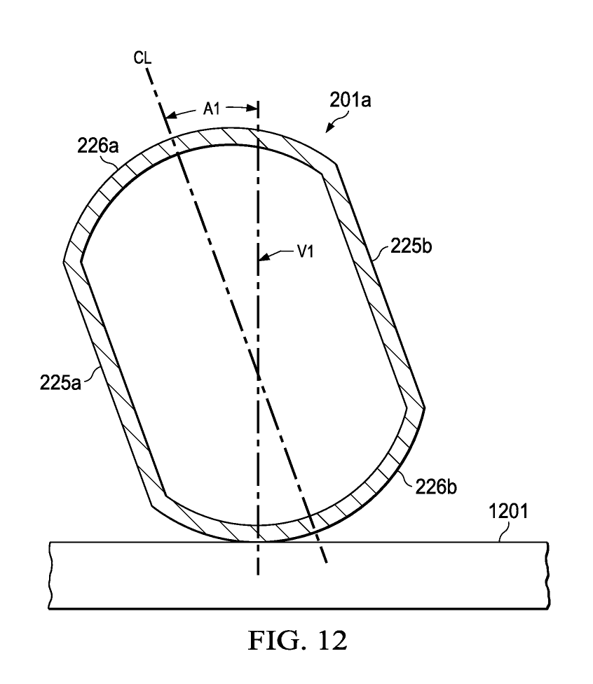

In one example embodiment, skid tube 201a has an inboard flat side wall 225a, an outboard flat side wall 225b, an upper rounded portion 226a, and a lower rounded portion 226b, each having a thickness. In one example embodiment, skid tube 201a is a straight constant thickness member that does not require chemical milling or bending. The cross section of skid tube 201a provides advantageous inertia qualities about the horizontal neutral axis and is resistant to buckling when landing on obstructions. Further, by canting the skid tube 201a at cant angle A1, the skid tube 201a maintains geometric inertial stiffness while also reducing the length of cross tubes 203a and 203b and also reducing the complexity of the saddle joint by having the centerline of the skid tube 201a being in the same plane as the centerline of the end portions 219a and 219b of cross tubes 203a and 203b, respectively. Referring in particular to FIG. 12, skid tube 201a is illustrated in a cross section view at cant angle A1, which in the illustrated embodiment is approximately 20°. FIG. 12 illustrates the interaction between an obstruction 1201 and a portion of skid tube 201a in that the orientation of skid tube 201a about cant angle A1 still provides the desired inertial stiffness when subjected to a load in an upward direction along vertical axis V1 while also enabling an efficient and aerodynamic attachment cross tubes 203a and 203b via saddles 209a-209d.

In the illustrated embodiment, forward cross tube 203a and aft cross tube 203b are each symmetric about a butt line zero plane. Forward cross tube 203a can include a straight horizontal portion 215a, a first bend 221a transitioning the straight horizontal portion 215a into a straight angled portion 217a, and a second bend 223a transitioning the straight angled portion 215a into a straight end portion 219a. Similarly, aft cross tube 203b can include a straight horizontal portion 215b, a first bend 221b transitioning the straight horizontal portion 215b into a straight angled portion 217b, and a second bend 223b transitioning the straight angled portion 215b into a straight end portion 219b. In one example embodiment, the centerline of the straight end portions 219a and 219b of cross tubes 203a and 203b, are in the same plane as a plane defined by the centerline of skid tube 201a along the length of skid tube 201a. Thus, the centerline of the straight end portions 219a and 219b of cross tubes 203a and 203b, and the skid tube 201a are all oriented at cant angle A1. In one example embodiment, cant angle A1 is approximately 20°. Another advantageous characteristic of cross tubes 203a and 203b is that the utilization of two bends on each side eliminates high stress concentrations that might otherwise be present in a single sharp bend, thereby increasing the fatigue tolerance of the cross tubes 203a and 203b.

The cross tubes 203a and 203b are each coupled to skids tubes 201a and 201b with saddles 209a-209d. In one example embodiment, each saddle 209a-209d is an identical common part. The outside diameters of the straight end portions 219a and 219b of cross tubes 203a and 203b are approximately the same as the thickness between inboard flat side wall 225a and outboard flat side wall 225b of the skid tube 201a, thereby allowing for a coupling mechanism, such as a saddle 209a to be used therebetween. Conventional saddles are very complicated and expensive members that must be forged, cast, or machined to a complicated geometry. In contrast, saddles 209a-209d can be made from a constant thickness sheet metal. In the example embodiment, each saddle 209a-209d can include an outboard planar portion 231b and an inboard planar portion 231a with a bend portion 233 therebetween, the outboard planar portion 231b being adjacent and parallel to the outboard flat side wall 225b of the skid tube 201a, the inboard planar portion 231a being adjacent and parallel to the inboard flat side wall 225a of the skid tube 201a. In one embodiment, the centerline of bend portion 233 lies in plane P1. The forward surface of bend portion 233 also acts as an aerodynamically advantageous profile to decrease drag that may otherwise be associated with a conventional saddle joint. A line of fasteners 235 can be used to attach the saddles 209a-209d to the cross tubes 203a and 203b. The fasteners 235 can be located along a crest line where the saddle contacts the outside diameter of the cross tube 203a. Fasteners 237 can be used to couple the saddles 209a-209d to the flat side walls of the skid tubes 201a and 201b. Flat side walls 225a and 225b provide an advantageous flat mating area to the planar surfaces 231a and 231b of saddle 209a thereby allowing a multiple row arrangement of fasteners 237 to be used. In another embodiment, skid tubes 201a and 201b can be round, thus in such an embodiment fasteners 237 could be located in a single line along the crest of the round skid tube.

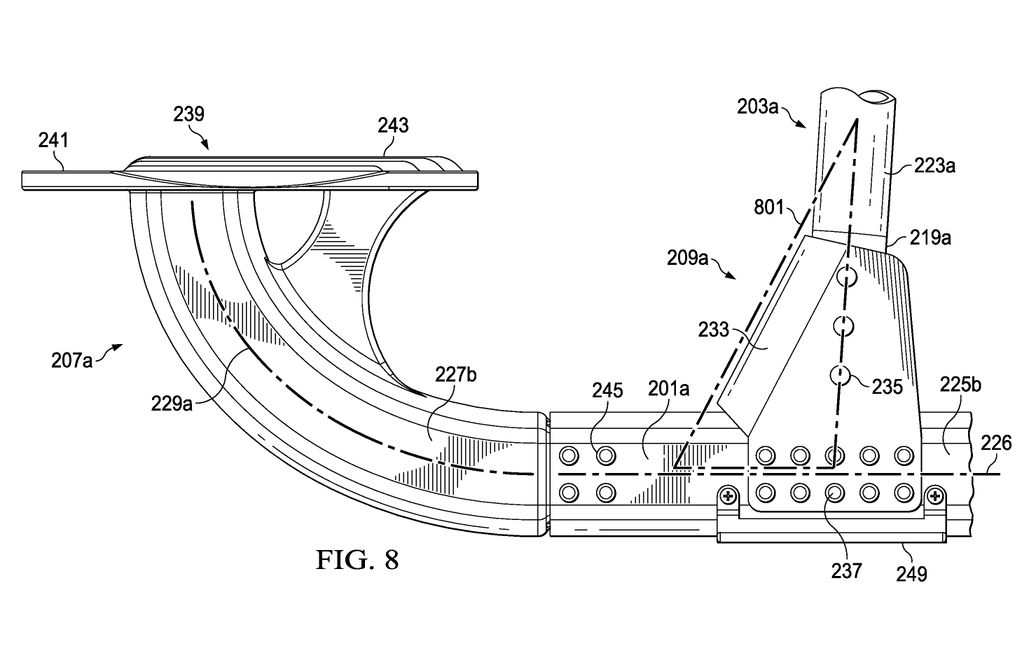

The configuration of saddles 209a-209d, cross tubes 203a and 203b, and skid tubes 201a and 201b produces an efficient and strong gusset shaped attachment without requiring a forged, casted, machined or other support member having a complicated geometry that would be expensive to manufacture. For example, the resulting gusset shape 801 is schematically illustrated in FIG. 8. Moreover, a method manufacturing each saddle 209a-209d can include cutting the overall shape out of a constant thickness sheet metal stock, and then bending each saddle 209a-209d to form bend portion 233.

In the example embodiment, step members 207a and 207b are configured as common parts in order save the expense associated with having unique left side and right side parts. Further, step members step members 207a and 207b are configured to be in aerodynamic alignment with skid tubes 201a and 201b, and end portions 219a and 219b of cross tubes 203a and 203b. To this end, a central axis 229a of step member 207a lies in a plane P1 defined by the central axes of straight end portions 219a and 219b of cross tubes 201a and 201b, and central axis 226 of skid tube 201a. Plane P1 is a plane in the fore/aft direction and is canted at cant angle A1. Axis 229a of step member 207a starts at a front end portion of skid tube 201a and curves upward and forward along plane P1 to a step portion 239. Step portion 239 can include an integral tow ring 241 and a striated portion 243. The striated portion 243 is configured as a stepping area for a person to ingress and egress the aircraft, e.g. helicopter 101. It should be appreciated that striated portion 243 can be any variety of implementation specific surfaces and geometries. In an example embodiment, striated portion 243 is crowned to promote an ergonomic stepping motion for the person as the contact of between a person's shoe and the striated portion 243 occurs during an egress or ingress. For example, since step member 207a is oriented at cant angle A1 and the step portion 239 being normal thereto, having striated portion 243 crowned provides an outboard contact surface for a person's shoe when the person is more outboard relative to the helicopter 101, and an inboard contact surface for a person's shoe when the person is more inboard relative to the helicopter 101 during the ingress or egress procedure. This feature allows the same step member 207a to be utilized on the left hand side or right hand side of the rotorcraft 101 and still provide an acceptable passenger step regardless of side or angle.

In one example embodiment, step member 207a can be coupled to skid tube 201a with fasteners 245. An aft portion of step member 207a fits within a forward portion of skid tube 201a. Interference features 247 can be implemented on the aft portion of step member 207a as localized assembly features that can be ground down until a tight fit is achieved to the interior of the forward portion of skid tube 201a.

The particular embodiments disclosed above are illustrative only, as the apparatuses and methods may be modified and practiced in different but equivalent manners apparent to those skilled in the art having the benefit of the teachings herein. Modifications, additions, or omissions may be made to the apparatuses described herein without departing from the scope of the invention. The components of the system may be integrated or separated. Moreover, the operations of the system may be performed by more, fewer, or other components.

Furthermore, no limitations are intended to the details of construction or design herein shown, other than as described in the claims below. It is therefore evident that the particular embodiments disclosed above may be altered or modified and all such variations are considered within the scope and spirit of the application. Accordingly, the protection sought herein is as set forth in the claims below.

To aid the Patent Office, and any readers of any patent issued on this application in interpreting the claims appended hereto, applicants wish to note that they do not intend any of the appended claims to invoke paragraph 6 of 35 U.S.C. §112 as it exists on the date of filing hereof unless the words “means for” or “step for” are explicitly used in the particular claim.

What is claimed is:

1. A landing gear for an aircraft, the landing gear comprising:
a skid tube having an inboard flat side wall and an outboard flat side wall, the skid tube having a skid tube centerline plane that is parallel to at least one of the outboard flat side wall and the inboard flat side wall, the skid tube being canted inboard at an angle;
a forward cross tube having a straight horizontal portion, a first bend transitioning the straight horizontal portion into a straight angled portion, and a second bend transitioning the straight angled portion into a straight end portion; and
a step member coupled to a forward end portion of the skid tube, the step member having a first inboard flat side wall and a first inboard flat side wall, the first inboard flat side wall and the first inboard flat side wall being parallel to the inboard flat side wall and the outboard flat side wall of the skid tube, respectively.

2. The landing gear according to claim 1, wherein the step member curves upward such that a step member central axis forms a first plane, and wherein the straight end portion of the forward cross tube has a straight end central axis that lies on the first plane defined by the step member.

3. The landing gear according to claim 1, the step member comprising:
a step portion having a tow ring opening at a forward portion of the step member.

4. The landing gear according to claim 1, the step member comprising:
a step portion having a striated portion

5. The landing gear according to claim 4, wherein the striated portion has a crowned geometry such that an inboard portion of the striated portion has a first normal vector directed toward a fuselage of the aircraft, and outboard portion of the striated portion has a second normal vector directed away from the fuselage of the aircraft.

6. The landing gear according to claim 1, the step member comprising:
a plurality of interference features at an aft portion of the step member.

7. The landing gear according to claim 1, comprising:
a saddle member for coupling the cross tube to the skid tube, the saddle member having an outboard planar portion and an inboard planar portion, with a bend portion therebetween, the outboard planar portion being adjacent and parallel to the outboard flat side wall of the skid tube, the inboard planar portion being adjacent and parallel to the inboard flat side wall of the skid tube.

8. The landing gear according to claim 7, wherein the bend portion of the saddle member provides an aerodynamic surface.

9. The landing gear according to claim 7, wherein a central bend axis of the bend portion of the saddle is located in the same plane as the skid tube centerline plane and a centerline axis of the straight end portion of the forward cross tube.

10. The landing gear according to claim 1, further comprising:
an aft cross tube having an aft straight horizontal portion, an aft first bend transitioning the aft straight horizontal portion into an aft straight angled portion, and an aft second bend transitioning the aft straight angled portion into an aft straight end portion.

11. The landing gear according to claim 1, wherein the angle is 20 degrees.

12. The landing gear according to claim 1, wherein the angle is between 0 degrees and 35 degrees.

13. A landing gear for an aircraft, the landing gear comprising:
a skid tube having an inboard flat side wall and an outboard flat side wall, the skid tube having a skid tube centerline plane that is parallel to at least one of the outboard flat side wall and the inboard flat side wall, the skid tube being oriented at a canted angle such that the skid tube centerline plane is canted at the canted angle relative to a fore/aft centerline plane of the aircraft;
a cross tube having a straight horizontal portion, a first bend that transitions the straight horizontal portion into a straight angled portion, and a second bend that transitions the straight angled portion into a straight end portion, the straight end portion being oriented at the same canted angle as the skid tube; and
a saddle member for coupling the cross tube to the skid tube, the saddle formed from a constant thickness sheet metal, the saddle member having an outboard planar portion and an inboard planar portion with a bend portion therebetween, the outboard planar portion being adjacent and parallel to the outboard flat side wall of the skid tube, the inboard planar portion being adjacent and parallel to the inboard flat side wall of the skid tube.

14. The landing gear according to claim 13, wherein the canted angle is 20 degrees.

15. The landing gear according to claim 13, wherein the canted angle is between 0 degrees and 35 degrees.

16. The landing gear according to claim 13, further comprising:
a step member coupled to a forward end portion of the skid tube, the step member having a first inboard flat side wall and a first inboard flat side wall, the first inboard flat side wall and the first inboard flat side wall being parallel to the inboard flat side wall and the outboard flat side wall of the skid tube, respectively.

17. The landing gear according to claim 16, wherein the step member curves upward such that a step member central axis forms a first plane, and wherein the straight end portion of the forward cross tube has a straight end central axis that lies on the first plane defined by the step member.

18. The landing gear according to claim 16, wherein the step member curves upward such that a step member central axis forms a first plane, and wherein a centerline axis of the straight end portion of the forward cross tube lies on the first plane.

19. The landing gear according to claim 13, the step member comprising:
a step portion having a tow ring opening forward of a striated portion.

20. The landing gear according to claim 19, wherein the striated portion has a crowned geometry such that an inboard portion of the striated portion has a first normal vector directed toward a fuselage of the aircraft, and outboard portion of the striated portion has a second normal vector away from the fuselage of the aircraft.
